(19) United States
(12) Patent Application Publication
(10) Pub. No.: US 2004/0255788 A1
(43) Pub. Date: Dec. 23, 2004

(54) Two part tea bag

(76) Inventor: Graham R. Bowe, Yardley, PA (US)

Correspondence Address: Richard C. Woodbridge, Esq., Synnestvedt Lechner & Woodbridge, LLP, P.O. Box 592, Princeton, NJ, 08542-0592, US

(21) Appl. No.: 10/870,214

(22) Filed: Jun. 17, 2004

Related U.S. Application Data
(60) Provisional application No. 60/479,300, filed on Jun. 18, 2003.

(51) Int. Cl. A47J 31/00

(52) U.S. Cl. 99/279

(57) ABSTRACT

A first and second infusible bag include respectively a tea or tea-like material and a complementary flavoring material and are detachably connected together so that they can be selectively steeped together or separately. Each infusible bag also has a string attached at one end to the bag and at the other end to a pair of tabs which are likewise detachably connected to each other. The entire configuration is normally stored in an air-tight, waterproof pouch. The invention can be conveniently used in one of three modes. In the first mode, both bags are placed unseparated in hot water and steep simultaneously. In a second mode, only the bags are separated and steeped separately in the hot water. In the third mode, the bags and the tabs are both separated and the bags can be conveniently steeped at separate times and at separate locations.

### CROSS-REFERENCE TO RELATED APPLICATIONS

This application claims the priority date of U.S. Provisional Patent Application Ser. No. 60/479,300 filed Jun. 18, 2003 and entitled Two-part Tea Bag, the entire contents and substance of which is hereby incorporated in total by reference.

### BACKGROUND OF THE INVENTION

1. Field of the Invention

The invention relates to a two part tea bag wherein both sections of the tea bag can be selectively separated and used separately, if so desired, to improve the overall flavor of the tea.

2. Description of Related Art

The use of infusible tea bags and the like has been known for a number of years. However, it does not appear to be any convenient way for a tea drinker to adjust his or her flavoring component to the tea.

One way to produce blends of infusible products is to employ a multi-chambered brewing device such as described in U.S. Pat. No. 4,901,630. While such a device might be useful at home, it is not useful when on the road or away from home.

Another approach is to mix the tea and the flavoring together as described, for example, in U.S. Pat. No. 4,851,252. See also U.S. Pat. No. 5,441,752.

In addition to the foregoing, there are teabags known that have multiple compartments but are typically used for brewing the same product. Perhaps best known among them is the V-Fold teabag made by the Thomas J. Lipton Company, a division of Conopco, Inc., Englewood Cliffs, N.J.

Lastly, U.S. Pat. No. 5,358,724, generally describes the state-of-the-art today.

While multi-chamber tea bags or coffee brewers are known to the art, there does not appear to be any convenient method that an individual can use to either brew a cup of tea with a fixed ratio of tea to flavorings or to, alternatively, selectively vary the ratio between the tea brewed and the flavorings.

It was in the context of the foregoing prior art that the present invention arose.

### SUMMARY OF THE INVENTION

Briefly described, the invention comprises an infusible apparatus for brewing tea and the like in combination with a flavoring and wherein the ratio between the brewed tea and the flavoring is infinitely adjustable. According to the preferred embodiment of the invention, a first infusible bag is attached to a second infusible bag by a weakened zone. The weakened zone is weakened sufficiently so that an individual can easily rip the two bags apart without tearing the compartments inside. The first infusible bag would typically and preferably include conventional tea, but the contents could also comprise herbal teas, or other tea-like substances. The second bag would preferably comprise a spice, such as ginger, vanilla or the like but could conceivably include other items that complement the taste of the tea brewed with the first bag. The first and second bags, respectively, include a string attached by a staple at one end and a tab located at the distal end of the string. The first and second tabs attached to the first and second distal ends of the pair of strings are preferably connected together at another weakened zone such that the tabs can be easily separated by an individual who desires to do so. Both bags are preferably sealed in an air-tight, moisture-proof pouch so that they can be opened for use at a later date.

The invention can be used in three modes.

According to the first mode, which is the preferred mode, the user takes the two infusible bags out of the pouch and places them in hot water in a conventional tea cup or the like. The user then steeps the two bags simultaneously in the hot water until the resulting brew is satisfactory for the user's consumption.

According to a second mode of use, the individual removes both infusible bags from the pouch and then separates both bags at the intermediate weakened zone using his or her hands. The user then places one of the two bags, typically the first bag including the tea or tea-like substance, into the hot water of the tea cup. When the tea or tea-like substance has steeped sufficiently, the user then removes the first tea bag from the tea cup using the common, unseparated, tabs and then places the second infusible bag into the brew. The second infusible bag typically includes a flavoring. It is contemplated in the second mode that the first and second infusible bags would be placed in the hot water for different periods of time so that the user can infinitely adjust the ratio of tea or tea-like substance to flavoring.

According to a third mode, if the user so chooses he or she can separate both tabs and bags and use both infusible bags totally separately. This might be practical, for example, where the user may choose to brew the tea at home but may choose to add the flavoring several hours later when he or she gets to work.

The invention will be more fully understood be reference to the following drawings:

### BRIEF DESCRIPTION OF THE DRAWINGS

FIG. 1A is a front view of the invention showing the first and second infusible bags connected to each other by a weakened zone and the first and second tabs, also connected by a weakened zone, prior to being placed into or being removed from a pouch.

FIG. 1B is a cross-sectional view of the two infusible bags sections as seen from perspective 1B-1B in FIG. 1A.

FIG. 2 is a partial cross-sectional view of the two-part tea bag invention shown inside an airtight, moisture-proof pouch.

FIG. 3 illustrates the first mode of use of the invention wherein both infusible bags are placed together into a cup of hot water and wherein neither the infusible bags nor the tabs are separated.

FIGS. 4A and 4B illustrate a second mode of the invention wherein the infusible bags are manually separated and steeped individually into hot water but wherein the tabs remain together.

FIGS. 5A and 5B illustrate the steps of brewing a flavored tea according to a third mode in which both the infusible bags and their associated tabs are separated so that they can be used at different times.

### DETAILED DESCRIPTION OF THE PREFERRED EMBODIMENT

During the course of this description like numbers will be used to identify like elements according to the different figures that illustrate the invention.

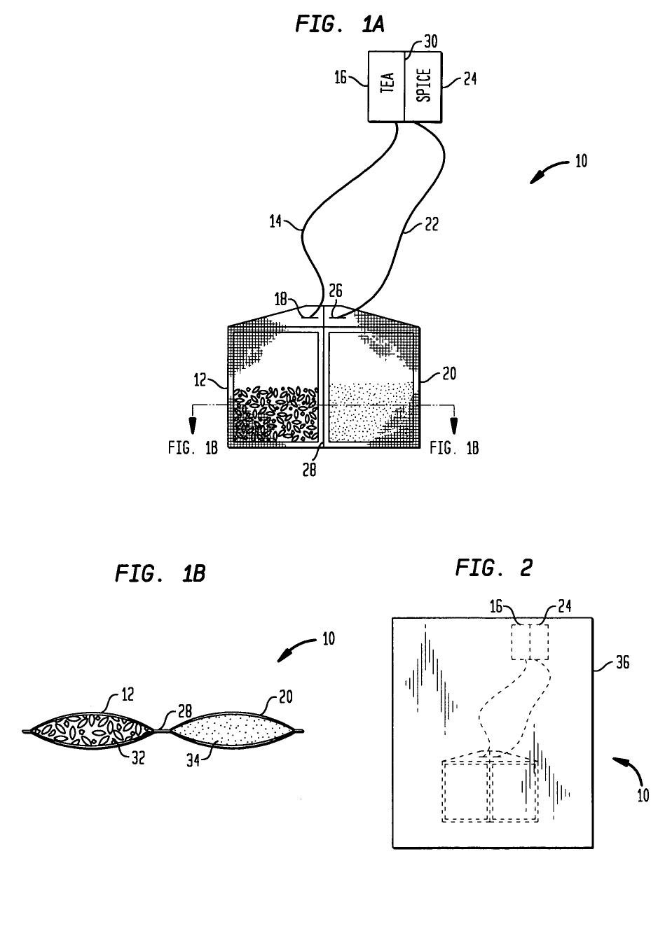

The invention 10 is illustrated in a front, elevational view in FIG. 1A. The invention 10 primarily comprises a first infusible bag 12 connected to a second infusible bag 20 separated by a weakened zone 28. The first infusible bag 12 is attached by a first string 14 to a first tab 16. One end of the string 14 is attached by a staple 18 in the conventional fashion to the top of the first infusible bag 12 and the second or distal end of the string 14 is attached to the tab 16 by glue, a staple or any similar conventional device.

Similarly, the second infusible bag 20 is connected by a second string 22 to a second tab 24. One end of string 22 is attached by a staple 26 to the top end of the second infusible bag 20 and the other end is attached by glue, a staple or the like in a conventional manner to tab 24. The material that comprises the bags 12 and 20 is preferably the same type of material used with conventional tea bags such as manufactured by the Thomas J. Lipton Company, Englewood Cliffs, N.J. or, alternatively, could comprise other suitable mesh materials such as cheesecloth or the like as is known to those of ordinary skill in the art.

The invention 10 is illustrated in FIG. 1B according to a cross-section 1B-1B as shown in FIG. 1a taken through the two bag sections 12 and 20. According to the preferred embodiment of the invention 10, conventional tea 32, such as Orange Pekoe and the like, is located in the first infusible bag 12. While conventional tea 32 is preferred, it will be appreciated by those of ordinary skill in the art that other tea-like substances such as herbal teas, chamomile and the like could also be placed inside of the first infusible bag 12. A spice 34 is preferably located in the second infusible bag 20. The material 34 inside of infusible bag 20 is meant to complement the tea or tea-like substance 32 in the first infusible bag 12. Conventional spices such as ginger and cloves would also work. Additional complementary materials 34 could include powdered honey, dehydrated fruit, essence of flowers, etc.

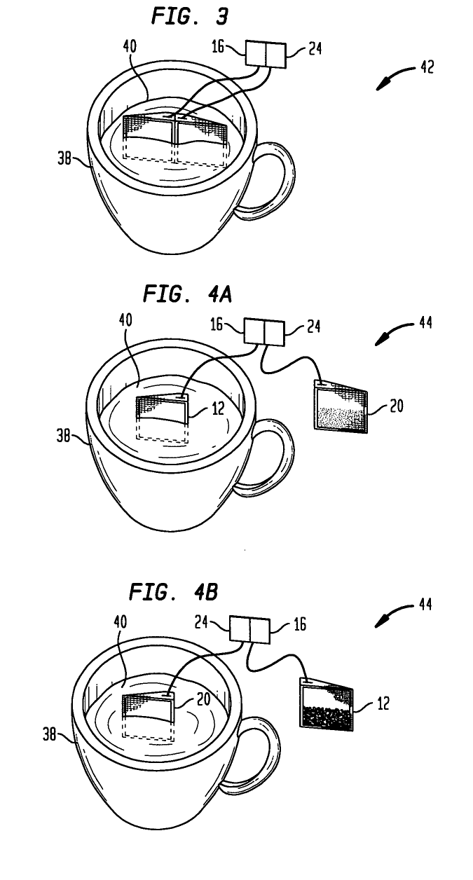

According to the preferred embodiment of the invention 10, the first and second infusible bags 12 and 20 and their related strings 14, 22 and tabs 16, 24 are preferably sealed inside of a pouch 36 as shown in FIG. 2. The pouch 36 is preferably airtight and water tight and formed from conventional materials known to those of ordinary skill in the art. Alternatively, pouch 36 could be nothing more than a simple paper wrapper as is frequently used by tea manufacturers.

The invention 10 can be used in three modes 42, 44 and 46 as illustrated respectively in FIGS. 3, 4A-4B, and 5A-5B.

The preferred mode 42 is illustrated in FIG. 3. A conventional coffee cup 38 is illustrated which can hold boiling water 40. The boiling water 40 may either be in the cup 38 before the infusion device 10 is inserted or may be placed in the cup 38 after the infusion device 10 is inserted. According to preferred mode 42, the two infusion bags 12 and 20 are placed into the hot water 40 in their unseparated, natural state as shown in FIG. 1A. In addition the tabs 16 and 26 are also in their natural, unseparated state. According to the first preferred mode 42, the tea or tea-like substance 32 in the first infusible bag 12 is steeped simultaneously with the flavoring or complementary substance 34 in the second infusible bag 20. This is obviously the fastest method since both the first and second infusible bags 12 and 20 steep simultaneously. It is preferable that the contents 32 and 34 be balanced in such a way as to be optimal for the average consumer. Mode 42 is not only economical from a time point of view but also from an efficiency point of view because one pull on the joined tabs 16 and 26 removes both infusible bags 12 and 20 quickly and simultaneously for ultimate removal or storage.

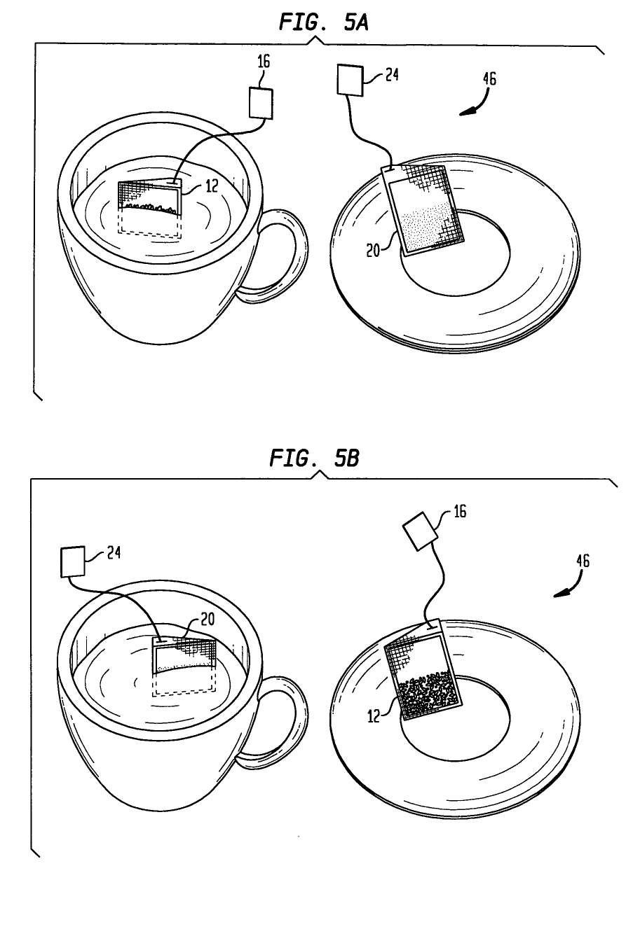

A second mode of use 44 is illustrated in FIGS. 4A and 4B. According to second mode 44, the user tears the first and second infusible bags 12 and 20 apart along the weakened zone 28. The weakened zone 28 preferably comprises a series of perforations between the first and second infusible bags 12 and 20 but, alternatively, could comprise removable tape, or the like. According to second mode 44, however, the tabs 16 and 24 remain attached. As a first step in the second mode 44, the first infusible bag 12 is placed into the hot water 40 until the tea has steeped to the satisfaction of the user as shown in FIG. 4A. Then the user removes the first infusible bag 12 and inserts the second infusible bag 20 containing the complementary flavoring as shown in FIG. 4B. The time that the complementary flavoring in the infusible bag 20 steeps as shown in FIG. 4B will be different from the time that the tea or tea-like substance 32 in infusible bag 12 steeps as shown in FIG. 4A. In this manner, the user of the invention 10 can infinitely and continuously vary the ratio between the steeping of the tea or tea-like substance 32 as shown in FIG. 4A versus the steeping of the complementary flavoring 34 as shown in FIG. 4B. This is a very efficient way to produce a brew to the optimal satisfaction of the user. The fact that the two tabs 12 and 24 remain attached makes it easier and cleaner for the user to remove the tea bags when finished and dispose of same.

A third mode of use 46 is illustrated in FIGS. 5A and 5B. According to third mode 46, the first and second infusible bags 12 and 20 are again separated in the manner described with regard to FIGS. 4A and 4B. In addition the two tabs 16 and 24 are also separated along their weakened zone 30. This permits the user to steep the tea or tea-like substance 32 as shown in FIG. 5A and to save the flavor or flavorings 34 in the second infusible bag 20 for steeping at a later date as shown in FIG. 5B. For example, a user may choose to brew his or her tea in the morning and, perhaps, consume some of it then. Later in the day he or she may take the tea to work and place the second infusible bag 20 into the brew as shown in FIG. 5B so as to produce a second type of flavored tea later in the day.

The foregoing capability is only possible with the invention as shown and described and provides the optimal way of brewing tea in any of the three modes 42, 44 or 46.

While the invention has been described with reference with the preferred embodiment thereof it will be appreciated by those of ordinary skill in the art that various modifications can be made to the structure and steps that comprise the invention without departing from the spirit and scope of the invention as a whole.

I claim:

1. A beverage infusions apparatus for use in a drinking vessel and for preparing an infusible beverage, said apparatus comprising:
a first infusible bag having a first infusible material therein;
a first string having a first end and a second end and wherein said first end is attached to said first infusible bag;
a first tab attached to said second end of said first string;
a second infusible bag having a second infusible material therein wherein said second infusible material is substantially different from said first infusible material in said first infusible bag;
a second string having a first end and a second end and wherein said first end is attached to said second infusible bag;
a second tab attached to said second end of said second string; and,
a pouch for enclosing and storing said first and second infusible bags, said first and second strings and said first and second tabs,
wherein a user of said apparatus can brew a beverage using said first and second bags either together or separately.

2. The apparatus of claims 1 wherein said first and second bags are attached to each other when in said pouch.

3. The apparatus of claim 2 wherein said first and second backs are connected to each other by a weakened section that can be easily torn so that the two bags can be easily separated.

4. The apparatus of claim 3 wherein said first and second tabs are connected to each other when in said pouch.

5. The apparatus of claim 4 wherein said first and second tabs are connected to each other by a weakened section that can be easily torn so that the two tags can be easily separated.

6. The apparatus of claim 5 wherein said first bag contains a tea like infusible material.

7. The apparatus of claim 6 wherein said second bag contains a flavoring to compliment the tea-like material in said first bag.

8. The apparatus of claim 7 wherein the tea-like infusible material is a material selected from the group consisting of Pekoe tea, green tee and herbal tea.

9. The apparatus of claim 8 wherein the flavoring to compliment the tea-like material is selected from the group consisting of sugar, artificial sweeteners, artificial cream, dried milk, clove, ginger, dehydrated honey, dehydrated fruit and essence of flowers.
